(19) United States
(12) Patent Application Publication
(10) Pub. No.: US 2025/0226141 A1
(43) Pub. Date: Jul. 10, 2025

(54) Electromagnetic Apparatus and Electronic Device

(71) Applicant: Huawei Digital Power Technologies Co., Ltd., Shenzhen (CN)

(72) Inventors: Jiangteng Zhang, Xi'an (CN); Zheng Ma, Xi'an (CN); Xiaofeng Yao, Shenzhen (CN)

(21) Appl. No.: 19/091,001

(22) Filed: Mar. 26, 2025

Related U.S. Application Data
(63) Continuation of application No. PCT/CN2023/120829, filed on Sep. 22, 2023.

(30) Foreign Application Priority Data
Sep. 26, 2022 (CN) 202211176320.3

(51) Int. Cl. H01F 27/02; H01F 27/10

(52) U.S. Cl. CPC H01F 27/022; H01F 27/025; H01F 27/10

(57) ABSTRACT

An electromagnetic apparatus includes a shell, a magnetic device, and a cover. A first end of the shell has an opening. The shell has an accommodating cavity inside. The accommodating cavity couples with the opening. The accommodating cavity is filled with a fluid thermally conductive medium. The cover has a first surface and a second surface that are opposite to each other. The magnetic device is fastened to the first surface of the cover. The first surface of the cover faces the first end of the shell, and the cover is fastened to the shell such that the magnetic device is located in the accommodating cavity, and the thermally conductive medium encapsulates the magnetic device. When the foregoing solution is used, the cover is fastened to the shell, and the magnetic device is located in the accommodating cavity, so that the thermally conductive medium can encapsulate the magnetic device.

### CROSS-REFERENCE TO RELATED APPLICATIONS

This is a continuation of International Patent Application No. PCT/CN2023/120829 filed on Sep. 22, 2023, which claims priority to Chinese Patent Application No. 202211176320.3 filed on Sep. 26, 2022, which are hereby incorporated by reference in their entireties.

### TECHNICAL FIELD

This disclosure relates to the field of electronic device technologies, and in particular, to an electromagnetic apparatus and an electronic device.

### BACKGROUND

A magnetic device is commonly used in an electronic device, for example, used in a device such as an inductor or a transformer. As a power device, the magnetic device has a high requirement on heat dissipation. The magnetic device is usually encapsulated through an adhesive with good thermal conductivity. After the adhesive cures, the magnetic device is put into use. This can protect the magnetic device, and can also transfer heat of the magnetic device. A current processing manner is usually encapsulating the magnetic device through an adhesive potting process and waiting for the adhesive to cure. However, a curing process takes a long time, which affects a production line progress, resulting in low production efficiency and high manufacturing costs.

### SUMMARY

This disclosure provides an electromagnetic apparatus and an electronic device, to improve production efficiency of a magnetic device.

According to a first aspect, this disclosure provides an electromagnetic apparatus that may include a shell, a magnetic device, and a cover. A first end of the shell may have an opening. The shell may have an accommodating cavity inside. The accommodating cavity may communicate with the opening. The accommodating cavity may be filled with a fluid thermally conductive medium. The cover has a first surface and a second surface that are opposite to each other. The magnetic device is fastened to the first surface of the cover. The first surface of the cover faces the first end of the shell, and the cover is fastened to the shell, so that the magnetic device is located in the accommodating cavity, and the thermally conductive medium encapsulates the magnetic device.

According to the technical solution provided in this disclosure, the cover is fastened to the shell, and the magnetic device is located in the accommodating cavity, so that the thermally conductive medium can encapsulate the magnetic device. In addition, the cover seals the shell to form a sealed structure, to prevent the fluid thermally conductive medium from leaking. The thermally conductive medium may gradually cure in the sealed structure formed by the cover and the shell. Therefore, after the cover seals the shell, a subsequent process can be performed, and a curing process can be omitted, thereby improving production efficiency of the magnetic device.

In an example implementable solution, a fastening bracket may be disposed on the first surface of the cover, and the magnetic device may be fastened to the fastening bracket. The magnetic device is fastened to the cover through the fastening bracket. It is convenient to connect the magnetic device to the cover.

When the fastening bracket is disposed, the fastening bracket may include a first fastening bracket and a second fastening bracket, and the first fastening bracket and the second fastening bracket may be disposed opposite to each other. The magnetic device may be disposed between the first fastening bracket and the second fastening bracket. Two ends of the magnetic device may be respectively fastened to the first fastening bracket and the second fastening bracket. The first fastening bracket and the second fastening bracket are respectively disposed at the two ends of the magnetic device, and the magnetic device is fastened by jointly using the first fastening bracket and the second fastening bracket, so that a position of the magnetic device is stable.

In an example implementable solution, a first limiting slot may be provided on a surface that is of the first fastening bracket and that faces the second fastening bracket, and a second limiting slot may be provided on a surface that is of the second fastening bracket and that faces the first fastening bracket. The two ends of the magnetic device may be respectively clamped to the first limiting slot and the second limiting slot. The magnetic device is connected to the first fastening bracket and the second fastening bracket in a clamping manner, to implement a convenient connection and easy disassembly.

In addition to the foregoing connection manner between the magnetic device and the fastening bracket, another connection manner may also be used. For example, the two ends of the magnetic device may be respectively bonded to the first fastening bracket and the second fastening bracket. The magnetic device is connected to the first fastening bracket and the second fastening bracket in a bonding manner, to implement a convenient connection.

In an example implementable solution, the electromagnetic apparatus may further include a sealing portion. The sealing portion may include a first sealing ring. The first sealing ring may be fastened to the first surface of the cover. When the cover is fastened to the shell, the first sealing ring may be crimped between the cover and the shell. When the cover and the shell are assembled, the first sealing ring seals a joint between the cover and the shell, to enhance sealing performance of the sealed structure formed by the cover and the shell.

In an example implementable solution, the sealing portion may further include a second sealing ring. The second sealing ring may be fastened to the first end of the shell. When the cover is fastened to the shell, the second sealing ring may be joined to the first sealing ring. The first sealing ring and the second sealing ring cooperate, to seal the joint between the cover and the shell when the cover and the shell are assembled, thereby further enhancing the sealing performance of the sealed structure formed by the cover and the shell.

When the cover is connected to the shell, the cover may be fastened to the shell through a plurality of connecting pieces. The plurality of connecting pieces may be distributed in a circumferential direction of the cover. In this way, it is convenient to connect and disassemble the cover and the shell.

In an example implementable solution, the cover may be provided with a plurality of first positioning holes distributed in the circumferential direction of the cover. The first end of the shell may be provided with a plurality of second positioning holes. The plurality of second positioning holes and the plurality of first positioning holes may be distributed in a one-to-one correspondence. The connecting pieces may pass through the first positioning holes and the second positioning holes to fasten the cover to the shell. The cover is connected to the shell in a manner of cooperation of the connecting pieces with the first positioning holes and the second positioning holes, to facilitate the connection between the cover and the shell.

In an example implementable solution, a lead rod may be disposed on the second surface of the cover. A conducting wire may be disposed in the lead rod. One end of the conducting wire may be electrically connected to the magnetic device, and the other end of the conducting wire may be located outside the shell. The conducting wire is disposed to facilitate a connection between an external device and the magnetic device located in the sealed structure formed by the cover and the shell.

In an example implementable solution, a positioning protrusion may be disposed in the accommodating cavity, and the magnetic device may abut against the positioning protrusion. The positioning protrusion may support the magnetic device, and may further limit the position of the magnetic device in the accommodating cavity. In this way, the position of the magnetic device is more stable.

In an example implementable solution, there may be a plurality of positioning protrusions, the magnetic device may include a plurality of electromagnetic units disposed side by side, and the plurality of positioning protrusions may be located between any two adjacent electromagnetic units. Positions of the plurality of electromagnetic units of the magnetic device are all limited by the positioning protrusions. In this way, the overall position of the magnetic device is stable.

According to a second aspect, this disclosure provides an electronic device that may include the electromagnetic apparatus according to any one of the implementable solutions of the first aspect. According to the technical solution provided in this disclosure, a curing process can be omitted in a manufacturing process of the electromagnetic apparatus. In this case, a manufacturing period is relatively short, and production efficiency is relatively high. Therefore, a manufacturing period of the electronic device can be shortened, and production efficiency of the electronic device can be improved.

In an example implementable solution, the electronic device may further include a circuit board. A positioning rod may be disposed at a first end of a shell of the electromagnetic apparatus. The positioning rod may be fastened to the circuit board. In this way, the electromagnetic apparatus may be fastened to the circuit board, to implement a simple connection manner, thereby facilitating connection and disassembly.

### BRIEF DESCRIPTION OF DRAWINGS

FIG. 1 is a diagram of a structure of a shell of an electromagnetic apparatus according to an embodiment of this disclosure;

FIG. 2 is a diagram of assembly of a cover and a magnetic device of an electromagnetic apparatus according to an embodiment of this disclosure;

FIG. 3 is a diagram of a structure of a cover of an electromagnetic apparatus from a perspective according to an embodiment of this disclosure;

FIG. 4 is a diagram of a structure of a first fastening bracket of an electromagnetic apparatus according to an embodiment of this disclosure;

FIG. 5 is a diagram of another structure of a first fastening bracket of an electromagnetic apparatus according to an embodiment of this disclosure; and

FIG. 6 is a diagram of a structure of a cover of an electromagnetic apparatus from another perspective according to an embodiment of this disclosure.

Reference numerals: 100: shell; 200: magnetic device; 300: cover; 400: electronic device; 500: connecting piece; 101: opening; 102: accommodating cavity; 103: positioning protrusion; 104: second positioning hole; 105: positioning rod; 106: second sealing ring; 201: electromagnetic unit; 301: first sealing ring; 302: first fastening bracket; 303: second fastening bracket; 304: first limiting slot; 305: first limiting protrusion; 306: lead rod; 307: air exhaust hole.

### DESCRIPTION OF EMBODIMENTS

The following describes in detail embodiments of this disclosure with reference to the accompanying drawings.

For ease of understanding, an application scenario of an electromagnetic apparatus in this disclosure is first described. The electromagnetic apparatus provided in embodiments of this disclosure may be used in an electronic device, for example, may be used in an electronic device such as an inductor, a transformer, or a power supply, and may be used as an impedance device, a transformer device, or the like inside the electronic device.

A magnetic device is usually encapsulated through an adhesive with good thermal conductivity. After the adhesive cures, the magnetic device is put into use. This implements physical protection and thermal conduction. A current processing manner is usually encapsulating the magnetic device through an adhesive potting process and waiting for the adhesive to cure. However, a curing process takes a long time, which affects a production line progress, resulting in low production efficiency and high manufacturing costs.

On this basis, embodiments of this disclosure provide an electromagnetic apparatus. The curing process in a manufacturing process of the magnetic device can be omitted, thereby shortening a manufacturing period of the magnetic device and improving production efficiency of the magnetic device.

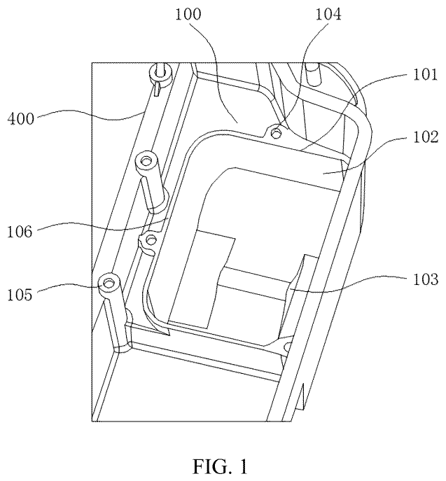

First, FIG. 1 is a diagram of a structure of a shell of an electromagnetic apparatus according to an embodiment of this disclosure, and FIG. 2 is a diagram of assembly of a cover and a magnetic device of an electromagnetic apparatus according to an embodiment of this disclosure. As shown in FIG. 1 and FIG. 2, the electromagnetic apparatus provided in this embodiment of this disclosure may include a shell 100, a magnetic device 200, and a cover 300. In actual application, the shell 100 may be integrated into a housing or a frame of an electronic device 400. For example, the shell 100 may be integrated into an inner wall of the housing of the electronic device 400. Further, the shell 100 may be integrated with the housing of the electronic device 400.

In a possible embodiment, a first end of the shell 100 may have an opening 101. The shell 100 may have an accommodating cavity 102 inside. The accommodating cavity 102 communicates with the opening 101. The shell 100 is a closed structure without the opening 101. In actual use, the accommodating cavity 102 may be filled with a fluid thermally conductive medium. The thermally conductive medium may cure and conduct heat. Further, the thermally conductive medium may be a potting adhesive or the like. In actual setting, a filling amount of the potting adhesive may be obtained by calculating a volume difference. Further, a volume of the accommodating cavity 102 is defined as V1, a volume of the magnetic device 200 is defined as V2, and the filling amount of the potting adhesive is defined as V. In this case, V≤V1−V2. In other words, the filling amount of the potting adhesive may be equal to or slightly less than a difference between the volume of the accommodating cavity 102 and the volume of the magnetic device 200.

In an example implementation, a positioning protrusion 103 may be disposed in the accommodating cavity 102. The positioning protrusion 103 can support the magnetic device 200, and limit a position of the magnetic device 200 in the accommodating cavity 102. In an example implementation, the magnetic device 200 may abut against the positioning protrusion 103. The magnetic device 200 may include a plurality of electromagnetic units 201 disposed side by side.

There may also be a plurality of positioning protrusions 103. The plurality of positioning protrusions 103 may be located between any two adjacent electromagnetic units 201. In an example, when the magnetic device 200 includes two electromagnetic units 201, one positioning protrusion 103 may be disposed between the two electromagnetic units 201, and the two electromagnetic units 201 may separately abut against the positioning protrusion 103, when the magnetic device 200 includes three electromagnetic units 201, two positioning protrusions 103 may be accordingly disposed, one positioning protrusion 103 may be disposed between every two adjacent electromagnetic units 201, and the two adjacent electromagnetic units 201 may separately abut against the positioning protrusion 103, and so on.

In a possible embodiment, the cover 300 may be in a flat plate-shaped structure. The cover 300 has a first surface and a second surface that are opposite to each other. The magnetic device 200 may be fastened to the first surface of the cover 300. During assembly, the first surface of the cover 300 may face the first end of the shell 100, and the cover 300 is fastened to the shell 100, so that the magnetic device 200 can be located in the accommodating cavity 102, and the fluid thermally conductive medium can encapsulate the magnetic device 200.

In an example implementation, the cover 300 may be fastened to the shell 100 through a plurality of connecting pieces 500. The plurality of connecting pieces 500 may be distributed in a circumferential direction of the cover 300, to enhance stability of the connection between the cover 300 and the shell 100. The connecting pieces 500 may be threaded connecting pieces 500. For example, screws or bolts may be used to facilitate assembly and disassembly of the cover 300 and the shell 100, thereby facilitating maintenance or replacement of the magnetic device 200. Further, when the connecting pieces 500 are disposed, the cover 300 may be provided with a plurality of first positioning holes distributed in the circumferential direction of the cover 300, and the first end of the shell 100 may be provided with a plurality of second positioning holes 104. The plurality of second positioning holes 104 and the plurality of first positioning holes may be distributed in a one-to-one correspondence. The connecting pieces 500 may pass through the first positioning holes and the second positioning holes 104, to fasten the cover 300 to the shell 100. The first positioning holes are not shown in FIG. 2. FIG. 2 shows a case in which the connecting piece 500 is located in the first positioning hole. When a threaded structure is disposed in a second positioning hole 104, the connecting piece 500 may be a screw. In this case, the second positioning hole 104 may be a blind hole or a through hole. When the second positioning hole 104 is an unthreaded hole, in other words, when no threaded structure is disposed in the second positioning hole 104, the connecting piece 500 may be a bolt. In this case, the second positioning hole 104 may be the through hole, the bolt passes through the second positioning hole 104, and the bolt penetrates the second positioning hole 104. The bolt cooperates with a nut, to fasten the cover 300 to the shell 100.

According to the electromagnetic apparatus provided in this embodiment of this disclosure, in actual application, the cover 300 is fastened to the shell 100, and the magnetic device 200 is located in the accommodating cavity 102, so that the thermally conductive medium can encapsulate the magnetic device 200. In addition, the cover 300 seals the shell 100 to form a sealed structure, to prevent the fluid thermally conductive medium from leaking. The thermally conductive medium may gradually cure in the sealed structure formed by the cover 300 and the shell 100. Therefore, after the cover 300 seals the shell 100, a subsequent process can be performed, and a curing process can be omitted, thereby improving production efficiency of the magnetic device and reducing manufacturing costs.

When the electromagnetic apparatus provided in this embodiment of this disclosure is used in the electronic device 400, the electromagnetic apparatus may be fastened to a circuit board of the electronic device 400. The circuit board is not shown in FIG. 2. Further, a positioning rod 105 may be disposed at the first end of the shell 100. The positioning rod 105 may be fastened to the circuit board, to fasten the electromagnetic apparatus to the circuit board. Further, the circuit board can be fastened to the positioning rod 105 through the threaded connecting piece 500. For example, the circuit board may be fastened to the positioning rod 105 through a screw. In an example, the screw may pass through the circuit board and be fastened to the positioning rod 105.

In a possible embodiment, the electromagnetic apparatus provided in this embodiment of this disclosure may further include a sealing portion, and the sealing portion may include a first sealing ring 301. The first sealing ring 301 may be fastened to the first surface of the cover 300. Further, the first sealing ring 301 may be bonded to the first surface of the cover 300. When the cover 300 is fastened to the shell 100, the first sealing ring 301 is crimped between the cover 300 and the shell 100. Further, the first sealing ring 301 is crimped between the cover 300 and the shell 100 in a circumferential direction of the first sealing ring 301. In other words, the entire first sealing ring 301 is crimped between the cover 300 and the shell 100, to seal a joint between the cover 300 and the shell 100 in the circumferential direction, thereby enhancing sealing performance of the sealed structure formed by the cover 300 and the shell 100.

In an example implementation, the sealing portion may further include a second sealing ring 106. The second sealing ring 106 may be fastened to the first end of the shell 100. Further, the second sealing ring 106 may be bonded to the first end of the shell 100. When the cover 300 is fastened to the shell 100, the second sealing ring 106 may be joined to the first sealing ring 301. Further, the second sealing ring 106 may have a same shape as the first sealing ring 301. When the cover 300 is joined to the shell 100, the entire second sealing ring 106 is joined to the entire first sealing ring 301 in the circumferential direction, to enhance the sealing performance of the joint between the cover 300 and the shell 100, thereby improving the sealing performance of the sealed structure formed by the cover 300 and the shell 100.

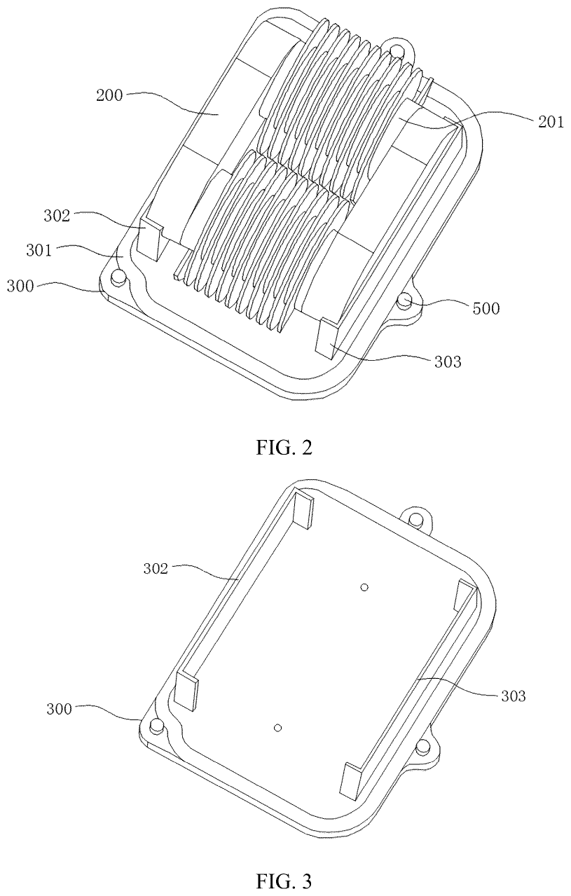

FIG. 3 is a diagram of a structure of a cover of an electromagnetic apparatus from a perspective according to an embodiment of this disclosure. The magnetic device is not shown in FIG. 3. With reference to FIG. 2 and FIG. 3, when the cover 300 is further disposed, a fastening bracket may be disposed on the first surface of the cover 300, and the magnetic device 200 may be fastened to the fastening bracket, to fasten the magnetic device 200 to the cover 300. In an example implementation, the fastening bracket may include a first fastening bracket 302 and a second fastening bracket 303. Both the first fastening bracket 302 and the second fastening bracket 303 are fastened to the first surface of the cover 300. The first fastening bracket 302 and the second fastening bracket 303 may be disposed opposite to each other. The magnetic device 200 may be disposed between the first fastening bracket 302 and the second fastening bracket 303. Two ends of the magnetic device 200 may be respectively fastened to the first fastening bracket 302 and the second fastening bracket 303. In this way, the magnetic device 200 is conveniently connected to the fastening bracket. This facilitates assembly and disassembly of the magnetic device 200.

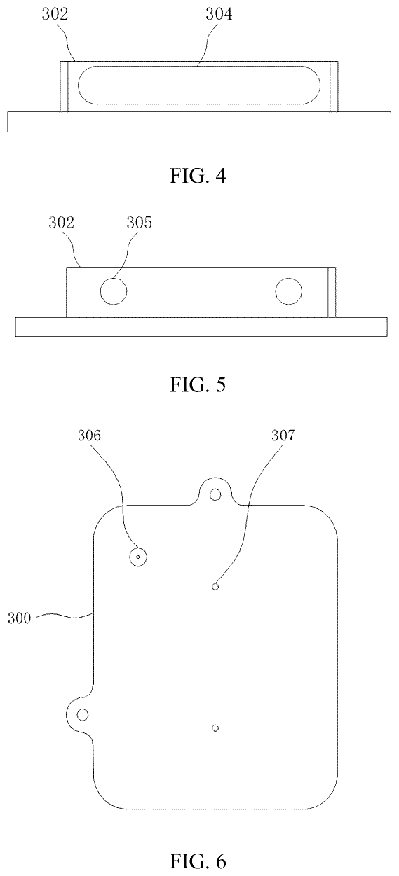

FIG. 4 is a diagram of a structure of a first fastening bracket of an electromagnetic apparatus according to an embodiment of this disclosure. A structure of the second fastening bracket is not shown in FIG. 4. For the structure of the second fastening bracket, refer to the structure of the first fastening bracket. For reference numerals in FIG. 4, refer to same numerals in FIG. 2. As shown in FIG. 4, in a possible implementation, a first limiting slot 304 may be provided on a surface that is of the first fastening bracket 302 and that faces the second fastening bracket 303, and correspondingly, a second limiting slot may be provided on a surface that is of the second fastening bracket 303 and that faces the first fastening bracket 302. Further, when the magnetic device 200 and the fastening bracket are assembled, the two ends of the magnetic device 200 may be respectively clamped to the first limiting slot 304 and the second limiting slot. More further, two ends of a magnetic core of the magnetic device 200 may be respectively clamped to the first limiting slot 304 and the second limiting slot.

FIG. 5 is a diagram of another structure of a first fastening bracket of an electromagnetic apparatus according to an embodiment of this disclosure. The structure of the second fastening bracket is not shown in FIG. 5. For the structure of the second fastening bracket, refer to the structure of the first fastening bracket. For reference numerals in FIG. 5, refer to same numerals in FIG. 2. As shown in FIG. 5, in another possible implementation, a third limiting slot and a fourth limiting slot may be respectively provided at the two ends of the magnetic device 200. Further, the third limiting slot and the fourth limiting slot may be respectively provided at the two ends of the magnetic core of the magnetic device 200. The magnetic device 200, the third limiting slot, and the fourth limiting slot are not shown in FIG. 5. A first limiting protrusion 305 may be provided on the surface that is of the first fastening bracket 302 and that faces the second fastening bracket 303, and a second limiting protrusion may be provided on the surface that is of the second fastening bracket 303 and that faces the first fastening bracket 302. Further, when the magnetic device 200 and the fastening bracket are assembled, the third limiting slot may be clamped to the first limiting protrusion 305, and the fourth limiting slot may be clamped to the second limiting protrusion.

In addition to the implementations shown in FIG. 4 and FIG. 5, in another possible implementation, the two ends of the magnetic device 200 may be respectively bonded to the first fastening bracket 302 and the second fastening bracket 303. In this case, the first fastening bracket 302 may be not provided with the first limiting slot 304, the second fastening bracket 303 may be not provided with the second limiting slot, and the magnetic device 200 is connected to the fastening bracket in only a bonding manner. Alternatively, the first fastening bracket 302 may be provided with the first limiting slot 304, and the second fastening bracket 303 may be provided with the second limiting slot. In this case, the magnetic device 200 is clamped and then bonded to the fastening bracket, so that the magnetic device 200 is more stably fastened to the fastening bracket. Alternatively, the first fastening bracket 302 may be provided with the first limiting slot 304, or the second fastening bracket 303 may be provided with the second limiting slot. In other words, one of the first fastening bracket 302 and the second fastening bracket 303 is not provided with a limiting slot, and the other one is provided with a limiting slot. The magnetic device 200 is bonded to the fastening bracket that is not provided with a limiting slot in the first fastening bracket 302 and the second fastening bracket 303. The magnetic device 200 is clamped to the fastening bracket that is provided with a limiting slot in the first fastening bracket 302 and the second fastening bracket 303. In addition, the magnetic device 200 may also be bonded to the fastening bracket that is provided with a limiting slot in the first fastening bracket 302 and the second fastening bracket 303. Similarly, in this case, the third limiting slot and the fourth limiting slot may be not respectively provided at the two ends of the magnetic device 200, and the first fastening bracket 302 and the second fastening bracket 303 may be not respectively provided with the first limiting protrusion 305 and the second limiting protrusion. In this case, the magnetic device 200 is connected to the fastening bracket in only a bonding manner. Alternatively, the third limiting slot and the fourth limiting slot may be respectively provided at the two ends of the magnetic device 200, and the first fastening bracket 302 and the second fastening bracket 303 may be respectively provided with the first limiting protrusion 305 and the second limiting protrusion. In this case, the magnetic device 200 is clamped and then bonded to the fastening bracket, so that the magnetic device 200 is more stably fastened to the fastening bracket. Alternatively, the third limiting slot may be provided at one end of the magnetic device 200, and the first limiting protrusion 305 may be provided at the first fastening bracket 302. In this case, one end of the magnetic device 200 and the first fastening bracket 302 are clamped through cooperation between the third limiting slot and the first limiting protrusion 305 and may also be bonded, and the other end of the magnetic device 200 is only bonded to the second fastening bracket 303.

FIG. 6 is a diagram of a structure of a cover of an electromagnetic apparatus from another perspective according to an embodiment of this disclosure. Further, FIG. 6 is a diagram of a structure of the second surface of the cover. For reference numerals in FIG. 6, refer to same numerals in FIG. 1. As shown in FIG. 6, a lead rod 306 may be disposed on the second surface of the cover 300. A conducting wire may be disposed in the lead rod 306. One end of the conducting wire may be electrically connected to the magnetic device 200, and the other end of the conducting wire may be located outside the shell 100. The conducting wire is not shown in FIG. 6. After the cover 300 and the shell 100 are assembled, the magnetic device 200 located in the sealed structure formed by the cover 300 and the shell 100 may be electrically connected to an external device through the conducting wire. There may be a plurality of lead rods 306. It may be understood that the lead rod 306 has a wire-through hole to accommodate the conducting wire. An aperture of the wire-through hole is small, and the wire-through hole may be sealed through a sealant, so that the fluid thermally conductive medium cannot leak out of the wire-through hole.

In an example implementation, the cover 300 may be provided with one or more air exhaust holes 307 with small diameters. When the cover 300 and the shell 100 are assembled, the air exhaust holes 307 may be provided, so that inner atmospheric pressure and outer atmospheric pressure of the sealed structure formed by the cover 300 and the shell 100 are equivalent, thereby preventing the fluid thermally conductive medium from leaking out of the joint between the cover 300 and the shell 100. It may be understood that the air exhaust holes 307 may be provided to help exhaust air in the accommodating cavity 102. However, because apertures of the air exhaust holes 307 are small, and the fluid thermally conductive medium has surface tension, the thermally conductive medium does not leak out of the air exhaust holes 307. In addition, the air exhaust holes 307 may be provided to help the fluid thermally conductive medium to cure.

The foregoing descriptions are example implementations of this disclosure, and are not intended to limit the protection scope of this disclosure. Any variation or replacement readily figured out by a person skilled in the art within the technical scope disclosed in this disclosure shall fall within the protection scope of this disclosure.

1. An electromagnetic apparatus, comprising comprising:
a shell comprising:
a first shell end comprising an opening; and
an accommodating cavity coupled to the opening and comprising a fluid thermally conductive medium;
a cover fastened to the shell and comprising:
a first cover surface facing the first shell end; and
a second cover surface that is opposite to the first cover surface;
a fastening bracket disposed on the first cover surface; and
a magnetic device fastened to the first cover surface using the fastening bracket, located in the accommodating cavity, and encapsulated by the fluid thermally conductive medium.

2. The electromagnetic apparatus of claim 1, wherein of the magnetic device comprises:
a first magnetic device end; and
a second magnetic device end.

3. The electromagnetic apparatus of claim 2, wherein the fastening bracket comprises:
a first fastening bracket; and
a second fastening bracket disposed opposite to the first fastening bracket,
wherein the magnetic device is disposed between the first fastening bracket and the second fastening bracket,
wherein the first magnetic device end is fastened to the first fastening bracket, and
wherein the second magnetic device end is fastened to the second fastening bracket.

4. The electromagnetic apparatus of claim 3, wherein the first fastening bracket comprises a first fastening bracket surface that faces the second fastening bracket, wherein the second fastening bracket comprises a second fastening bracket surface that faces the first fastening bracket, and wherein the electromagnetic apparatus further comprises:
a first limiting slot located on the first fastening bracket surface, wherein the first magnetic device end is clamped to the first limiting slot; and
a second limiting slot located on the second fastening bracket surface wherein the second magnetic device end is clamped to the second limiting slot.

5. The electromagnetic apparatus of claim 3, wherein the first magnetic device end is bonded to the first fastening bracket, and wherein the second magnetic device end is bonded to the second fastening bracket.

6. The electromagnetic apparatus of claim 1, further comprising a sealing portion, wherein the sealing portion comprises a first sealing ring fastened to the first cover surface, and wherein the first sealing ring is configured to crimp between the cover and the shell when the cover is fastened to the shell.

7. The electromagnetic apparatus of claim 6, wherein the sealing portion further comprises a second sealing ring fastened to the first shell end, and wherein the second sealing ring is configured to join to the first sealing ring when the cover is fastened to the shell.

8. The electromagnetic apparatus of claim 1, wherein the cover is configured to fasten to the shell through connecting pieces, and wherein the connecting pieces are distributed in a circumferential direction of the cover.

9. The electromagnetic apparatus of claim 8, wherein the cover further comprises first positioning holes distributed in the circumferential direction, wherein the first shell end comprises second positioning holes, wherein the second positioning holes and the first positioning holes are distributed in a one-to-one correspondence, and wherein the connecting pieces pass through the first positioning holes and the second positioning holes to fasten the cover to the shell.

10. The electromagnetic apparatus of claim 1, further comprising:
a lead rod disposed on the second cover surface; and
a conducting wire disposed in the lead rod and comprising:
a first conducting wire end electrically coupled to the magnetic device; and
a second conducting wire end located outside of the shell.

11. The electromagnetic apparatus of claim 1, further comprising a positioning protrusion disposed in the accommodating cavity, and wherein the magnetic device is configured to abut against the positioning protrusion.

12. The electromagnetic apparatus of claim 11, wherein the magnetic device comprises electromagnetic units disposed side by side, and wherein the positioning protrusion is located between adjacent electromagnetic units of the electromagnetic units.

13. An electronic device comprising:
an electromagnetic apparatus comprising:
a shell comprising:
a first shell end comprising an opening; and
an accommodating cavity coupled to the opening and comprising a fluid thermally conductive medium;
a cover fastened to the shell and comprising:
a first cover surface facing the first shell end; and
a second cover surface located opposite to the first cover surface;
a fastening bracket disposed on the first cover surface; and
a magnetic device fastened to the first cover surface using the fastening bracket, located in the accommodating cavity, and encapsulated by the thermally conductive medium;
a circuit board; and
a positioning rod disposed at the first shell end and fastened to the circuit board.

14. The electronic device of claim 13, wherein the magnetic device comprises:
a first magnetic device end; and
a second magnetic device end.

15. The electronic device of claim 14, wherein the fastening bracket comprises:
a first fastening bracket; and
a second fastening bracket disposed opposite to the first fastening bracket, wherein the magnetic device is disposed between the first fastening bracket and the second fastening bracket, wherein the first magnetic device end is fastened to the first fastening bracket, and wherein the second magnetic device end is fastened to the second fastening bracket.

16. The electronic device of claim 15, wherein the first fastening bracket comprises a first fastening bracket surface that faces the second fastening bracket, wherein the second fastening bracket comprises a second fastening bracket surface that faces the first fastening bracket, and wherein the electromagnetic apparatus further comprises:
a first limiting slot located on the first fastening bracket, wherein the first magnetic device end is clamped to the first limiting slot; and
a second limiting slot located on the second fastening bracket surface, wherein the second magnetic device is clamped to the second limiting slot.

17. The electronic device of claim 15, wherein the first magnetic device end is bonded to the first fastening bracket, and wherein the second magnetic device end is bonded to the second fastening bracket.

18. The electronic device of claim 13, wherein the electromagnetic apparatus further comprises a sealing portion, wherein the sealing portion comprises a first sealing ring fastened to the first cover surface, and wherein the first sealing ring is configured to crimp between the cover and the shell when the cover is fastened to the shell.

19. The electronic device of claim 18, wherein the sealing portion further comprises a second sealing ring fastened to the first shell end, and wherein the second sealing ring is configured to join to the first sealing ring when the cover is fastened to the shell.

20. The electronic device of claim 13, wherein the cover is configured to fasten to the shell through connecting pieces, and wherein the connecting pieces are distributed in a circumferential direction of the cover.
